(19) United States
(12) Patent Application Publication
(10) Pub. No.: US 2013/0284566 A1
(43) Pub. Date: Oct. 31, 2013

(54) CONVEYANCE TRAY AND CONVEYANCE SYSTEM THEREOF

(71) Applicant: TIA-JING LIU, New Taipei City (TW)

(72) Inventor: TIA-JING LIU, New Taipei City (TW)

(21) Appl. No.: 13/586,039

(22) Filed: Aug. 15, 2012

(30) Foreign Application Priority Data
Apr. 28, 2012 (CN) 201210133433.5

(51) Int. Cl. B65D 25/10; B65G 37/00

(52) U.S. Cl. 198/803.12; 269/303

(57) ABSTRACT

A conveyance tray and a conveyance system thereof are disclosed. The conveyance tray is used for the conveyance system to convey a test object. The test object has a depressed part. The conveyance tray includes a bottom plate and a fixed part. The bottom plate is used for carrying the test object. The fixed part is disposed on the bottom plate and used for fitting in with the depressed part to fix the test object.

### BACKGROUND OF THE INVENTION

1. Field of the Invention

The present invention relates to a conveyance tray and a conveyance system thereof, and more particularly, to a conveyance tray makes use of a fixed part to fix a test object and a conveyance system thereof.

2. Description of the Related Art

In the production test process of nowadays factory, in order to accelerate the pace of production or test, make use of a conveyance system to convey products is widely applied in various types of production processes.

Please refer to FIG. 1 first, which is a diagram showing conventional conveyance system in the prior art.

In the prior art, a conveyance system 90 includes a conveyance belt 91, a conveyance tray 92, and other powered device (not shown in the drawing), wherein the powered device is used to drive the movement of conveyance belt 91. A plurality of conveyance tray 92 are set onto the conveyance belt 91, wherein each conveyance tray 92 is used to carry a test object 93, and is driven to move by the conveyance belt 91. As shown in FIG. 1, the conveyance belt 91 is moved towards the left. When the conveyance tray 92 starts to move from a standstill or stops at a standstill from a movement, the test object 93 will move towards the opposite direction of the operation of the conveyance belt 91 due to inertia effect. As a result, this would make the test object 93 displaced and offset the correct location. Therefore, in the prior art, the conveyance tray 92 has a plurality of fixed edge 921 disposed thereon, by means of disposing the fixed edge 921 around the test object 93 so that the test object 93 does not move. However, the setting position of the fixed edge 921 must match the dimensions of the test object 93, the position of the fixed edge 921 need to be readjusted and designed when testing different specifications or different sizes of test object 93.

On the other hand, the prior art has also disclosed the method by taking advantage of increasing the friction coefficient of the conveyance tray 92 to make the test object 93 is not easy to slide. Nevertheless, the test object 93 is easily to get scratched with this manner. In addition, the prior art has also revealed the method of installing positioning detection device to detect the position of the test object 93. But the cost of the positioning detection device is high, and also need to increase the time for adjusting and testing positioning detection device.

### SUMMARY OF THE INVENTION

A primary object of the present invention is to provide a conveyance tray, which makes use of a fixed part to fix a test object.

Another primary object of the present invention is to provide a conveyance system possesses aforementioned conveyance tray.

In order to achieve the above objects, the conveyance tray of the present invention is used in the conveyance system to convey a test object. The test object has a depressed part. The conveyance tray includes a bottom plate and a fixed part. The bottom plate is used for carrying the test object. The fixed part is disposed on the bottom plate and used for fitting in with the depressed part to fix the test object.

The conveyance system of the present invention includes a conveyance belt and a conveyance tray. The conveyance tray is disposed on the conveyance belt and is driven to move by the conveyance belt. The conveyance tray includes a bottom plate and a fixed part. The bottom plate is used for carrying the test object. The fixed part is disposed on the bottom plate and used for fitting in with the depressed part to fix the test object.

### BRIEF DESCRIPTION OF THE DRAWINGS

FIG. 1 is a diagram showing a conveyance system of the prior art.

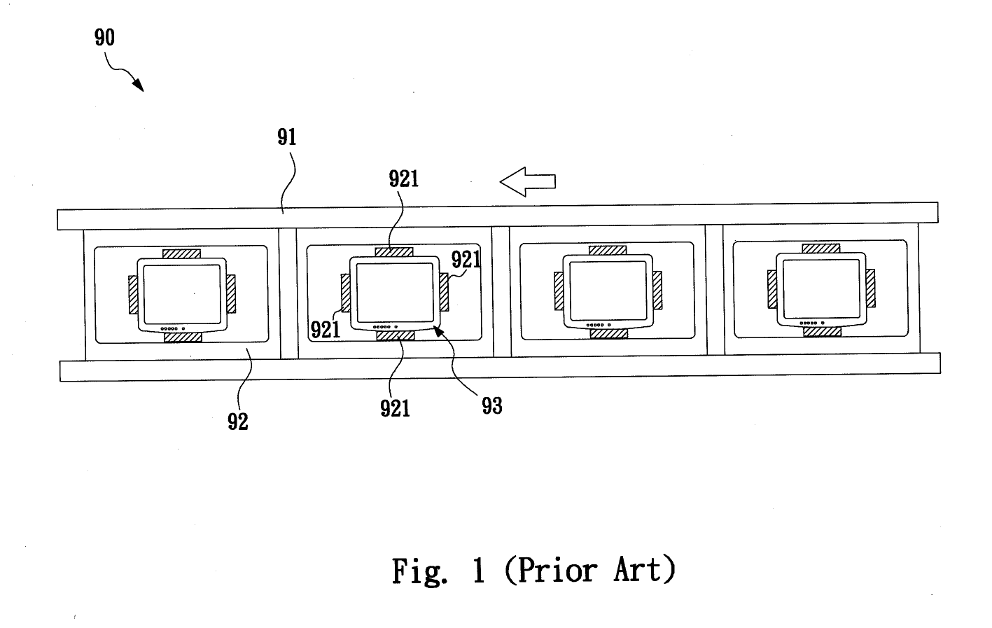

FIG. 2 is a diagram showing the conveyance system of the present invention.

FIG. 3 is a schematic view showing the manner in which the conveyance tray assembles the test object of the present invention

FIG. 4 is a plan view showing the assemblage of the test object and the conveyance tray of the present invention.

### DETAILED DESCRIPTION OF THE PREFERRED EMBODIMENTS

The advantages and innovative features of the invention will become more apparent from the following detailed description when taken in conjunction with the accompanying drawings.

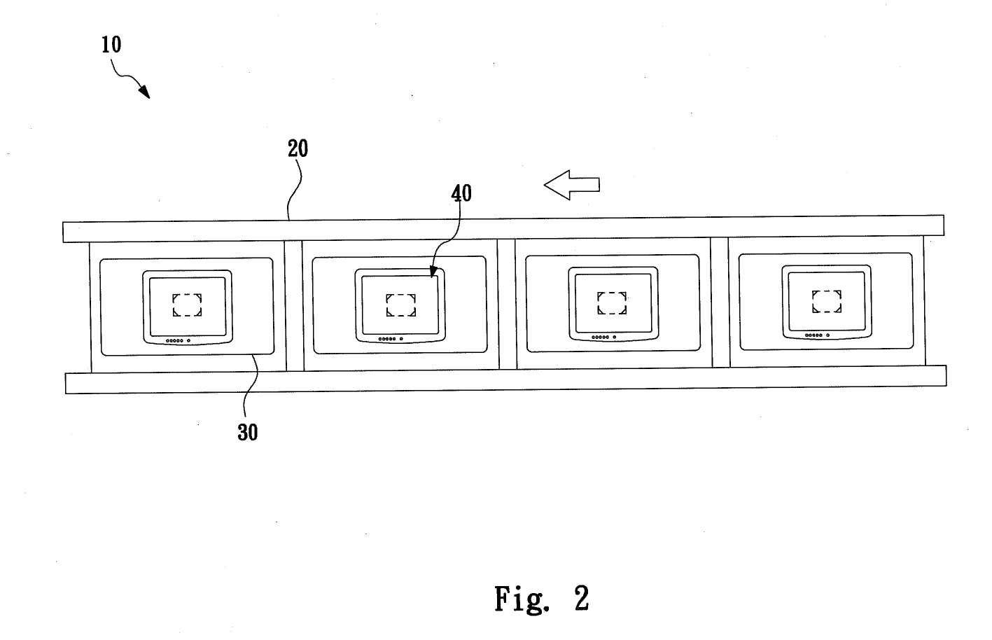

Please refer to FIG. 2, which is a diagram showing the conveyance system of the present invention.

The conveyance system 10 of the present invention includes a conveyance belt 20, a conveyance tray 30, and other powered device (not shown in the drawing) to drive the movement of the conveyance belt 20. As shown in the FIG. 2, the conveyance belt 20 is moved toward the left, but the present invention is not limited to this direction. As the method of making the conveyance belt 20 to move has applied widely by those skilled in the art, and it's not the focus of the improvement of present invention. Therefore it is no more described. The conveyance system 10 is used for carrying the test object 40, wherein the test object 40 is assembled or tested automatically. In FIG. 2, the test object 40 is shown as a display device for illustrative purpose only, and is not meant to be a limitation of the present invention. And further, the test object has a depressed part 41. In the present embodiment, the depressed part 41 is disposed on the back of the test object 40, but the present invention is not limited to this aspect.

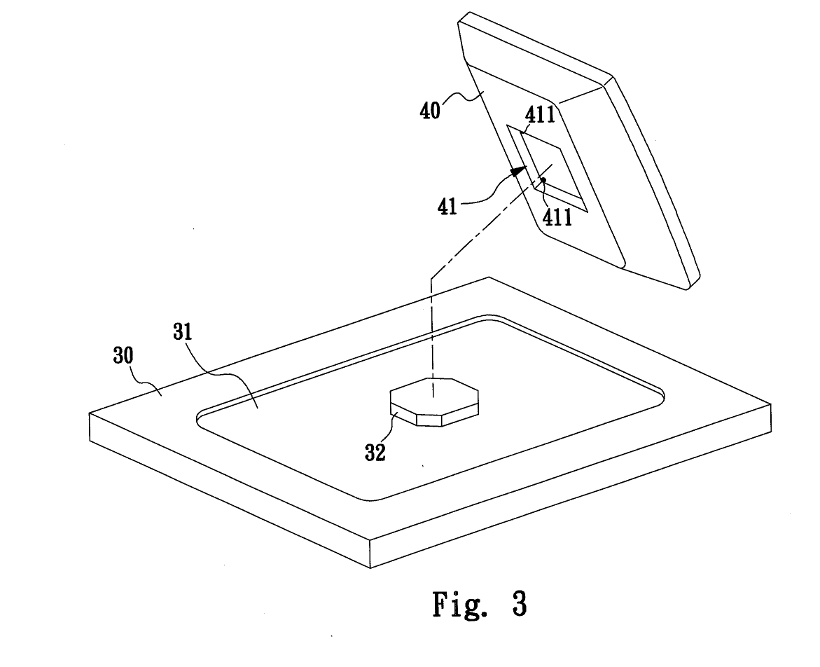

A plurality of conveyance tray 30 is disposed on the conveyance belt 20, in order to move along with the conveyance belt 20 at the same time. With regard to the structure of the conveyance tray 30, please refer to FIG. 3, which is a schematic view showing the manner in which the conveyance tray assembles the test object according to the embodiment of the present invention.

The conveyance tray 30 includes a bottom plate 31 and a fixed part 32. The bottom plate 31 is used for carrying the test object 40, so that the test object 40 can move together with the conveyance tray 30. The fixed part 32 is set onto the center of the bottom plate 31 substantially to fit in with the size and position of the depressed part 41 of the test object 40, wherein the test object 40 can be fixed through the engagement of the fixed part 32 and the depressed part 41 when disposed on the bottom plate 31. As a result, the test object 40 will not offset the correct position due to the movement of the bottom plate 31. The height of the fixed part 32 could be 6 mm to fit in with the depth of the depressed part 41, but the present invention is not limited to this aspect. The interior of the depressed part 41 of the test object 40 can be also provided with a plurality of assembly 411, such as a screw. The shape of the fixed part 32 is to fit in with the position of the plurality of assembly 411 to keep away from the assembly 411, and to make the engagement of the fixed part 32 and the test object 40 much more firmly. The fixed part 32 can be an octagon, but the present invention is not limited to this aspect.

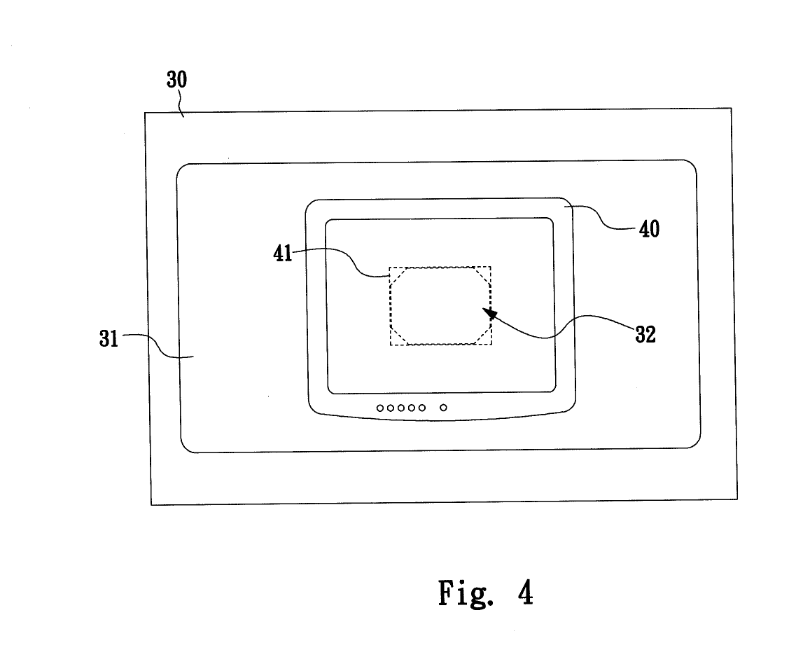

Finally, please refer to FIG. 4, which is a plan view showing the assemblage of the test object and the conveyance tray according to the embodiment of the present invention.

The final plan view showing the assembling of the test object 40 and the conveyance tray 30 is as shown in FIG. 4. As described in aforementioned description, the test object 40 can be disposed onto the bottom plate 31 firmly by using the fixed part 32, wherein the test object 40 is unable to shift arbitrarily but remains in the original position when the conveyance tray 30 moves. And the position and the size of the fixed part 32 are not required to be changed in accordance with the dimensions of different test object 40.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A conveyance tray, used in a conveyance system to convey a test object, wherein the test object has a depressed part, the conveyance tray comprising:
a bottom plate for carrying the test object; and
a fixed part disposed on the bottom plate for fitting in with the depressed part to fix the test object.

2. The conveyance tray as claimed in claim 1, wherein the fixed part is set on the center of the bottom plate substantially.

3. The conveyance tray as claimed in claim 1, wherein the depressed part of the test object has a plurality of assembly, and a shape of the fixed part is to fit in with a position of the plurality of assembly of the test object.

4. The conveyance tray as claimed in claim 3, wherein the fixed part is an octagon.

5. The conveyance tray as claimed in claim 1, wherein a height of the fixed part is 6 mm.

6. A conveyance system, used to convey a test object, wherein the test object has a depressed part, the conveyance system comprising:
a conveyance belt; and
a conveyance tray disposed on the conveyance belt to move by the conveyance belt, wherein the conveyance tray comprises:
a bottom plate for carrying the test object; and
a fixed part disposed on the bottom plate and for fitting in with the depressed part to fix the test object.

7. The conveyance system as claimed in claim 6, wherein the fixed part is set on the center of the bottom plate substantially.

8. The conveyance system as claimed in claim 6, wherein the depressed part of the test object has a plurality of assembly, and a shape of the fixed part is to fit in with a position of the plurality of assembly of the test object.

9. The conveyance system as claimed in claim 8, wherein the fixed part is an octagon.

10. The conveyance system as claimed in claim 6, wherein a height of the fixed part is 6 mm.
